(19) United States
(12) Patent Application Publication
(10) Pub. No.: US 2007/0022160 A1
(43) Pub. Date: Jan. 25, 2007

(54) Method of managing privileged conversations in an instant conversation system

(75) Inventors: Anthony Dauguet, Saint Pierre Du Fresne (FR); Olivier Briand, Caen (FR); Sophie Ferron, Rennes (FR)

Correspondence Address: COHEN, PONTANI, LIEBERMAN & PAVANE LLP, Suite 1210, 551 Fifth Avenue, New York, NY, 10176, US

(73) Assignee: France Telecom, Paris (FR)

(21) Appl. No.: 11/485,110

(22) Filed: Jul. 12, 2006

(30) Foreign Application Priority Data
Jul. 12, 2005 (FR) 0507445

(51) Int. Cl. G06F 15/16

(52) U.S. Cl. 709/204

(57) ABSTRACT

A method of managing privileged conversations in an electronic instant conversation service comprising a plurality of clients connected to a messaging server, each client having at least one state of presence visible to the other clients that varies at least between “Available” and “Busy” or “Offline”. The method comprises a step in which a first client sends a request for privileged conversation with a second client and, in response to that request, a step in which the state of presence of said first client is changed to “Busy” or “Offline” for all clients other than said second client.

### FIELD OF THE INVENTION

The present invention relates to electronic instant conversation systems such as instant messaging services and chat services. It relates more particularly to managing conversations in such systems.

### BACKGROUND OF THE INVENTION

In real-time electronic conversation systems, such as instant messaging systems, users exchange messages in real time. FIG. 2 shows a simplified example of a standard instant messaging system that comprises an instant messaging server 100 to which two users A and B are connected via their respective instant messaging clients C_A and C_B. The server 100 includes a main instant messaging module 110 for managing the state of presence of and the exchange of messages between instant messaging clients as a function of instant message routing rules. This module also manages all the contacts lists 120 (also known as “buddy lists”) of each instant messaging client, such as the lists 121 and 122 respectively corresponding to the contacts lists of users A and B.

The state of presence/availability of a user is a dynamic parameter visible to other users. It may generally vary between “Present” and “Absent” or “Available” and “Busy”. These states of presence define the communicate capacity of a user for all of the contacts in the list. It is the users themselves who decide on their own states of presence. In certain cases, they can program a change of state of presence as a function of time, for example to change to an “Absent” state of presence after a certain period of inactivity.

In FIG. 2, if user B is seeking to communicate with user A by means of instant messages, user B first looks up the state of presence of user A as indicated in B's own contacts list 122. If user A has a state of presence set to “Available”, for example, user B knows that a message can be sent to user A immediately in order to enter into communication with A. However, if the state of presence of user A indicated in B's contacts list is “Absent” or “Busy”, then user B knows that user A is temporarily unavailable and will not respond immediately.

At present, an instant messaging user can be totally “Busy” or partly “Busy”. When partly “Busy”, users may choose to be “Busy” for 90% of the contacts in their contacts lists, and “Available” for the remaining 10%, for example. This corresponds to the concept of differentiated state of presence and availability management whereby users select for a given period the contact(s) from their lists with whom they wish to communicate.

However, during an instant messaging conversation, users have no simple, fast, and efficient way to declare themselves available for only one or more contacts participating in the conversation that they wish to “privilege” at the time. To have a privileged conversation with (i.e. to exchange instant messages with) only one or more specified contacts, users must, firstly, advise all the other contacts with whom they are already in conversation (except those they wish to privilege) that they will be temporarily unavailable and then, secondly, declare themselves unavailable for the whole of the rest of their contacts lists (“buddy lists”), except for those contacts they wish to privilege, and they must do this each time by changing their states of presence manually.

This absence of any simple and fast means of limiting the number of parties involved in simultaneous conversations represents a serious drawback because of the growing use of instant messaging, in particular in business, where the number of simultaneous calls for attention, referred to herein as “solicitations” can rapidly become large. Without such means, and starting from a certain number of simultaneous conversations, for example three simultaneous conversations, it is difficult for a user to follow all the conversations and to respond to everyone quickly, although this is the very idea of electronic instant conversation systems.

### OBJECT AND SUMMARY OF THE INVENTION

The present invention aims to remedy the above-mentioned drawbacks and to propose a simple and efficient technical solution whereby a user of an electronic instant conversation system can privilege or prioritize an instant conversation with one or more chosen contacts, without having to be concerned for the time being with other actual or potential solicitations that might occur.

These objects are achieved by a method of managing privileged conversations in an electronic instant conversation service comprising a plurality of clients connected to a messaging server, each client having at least one state of presence visible to the other clients that varies at least between “Available” and “Busy” or “Offline”. The method comprises a step in which a first client sends a request for privileged conversation with a second client and a step in which, in response to that request, the state of presence of said first client is changed to “Busy” or “Offline” for all the clients other than said second client.

Thus, by using the method of the present invention, the user of an electronic instant conversation service (e.g. instant messaging or chat) can, at any time in an instant conversation, decide on which other user(s) to have privileged conversation. The user's state of presence is therefore managed automatically as a function of that privileged conversation request and the client indicated therein. For all other users participating in the conversation and who are not privileged, the user's state of presence then changes to “Busy” or “Offline”.

Clients already in conversation with the first client requesting a privileged conversation with a second client may be informed of the temporary unavailability of the first client by sending out an unavailability message that may be configured (personalized) in advance by the user and then stored on the messaging server.

Instant messages sent by clients other than the privileged client participating in the conversation are treated in the same way as messages sent to a user whose state of presence is “Offline”, which may be stored temporarily on the messaging server for the duration of the privileged conversation and then forwarded to the client at the end of the privileged conversation or redirected to the client in the form of standard electronic mail messages.

The method of the invention may be implemented by a computer program on an electronic instant conversation server and comprising instructions for executing the steps of the method described above.

This program may be made available by downloading it. The invention therefore relates to a method of using the above program that includes a step of making said program available by downloading it.

The invention also provides an electronic instant conversation server comprising a main messaging module for managing the exchange of instant messages between clients each having at least one state of presence visible by the other clients that varies at least between “Available” and “Busy” or “Offline”. The server further comprises a privileged conversation management module adapted, in response to a request from a first client for privileged conversation with a second client, to change the state of presence of said first client to “Busy” or “Offline” for all clients other than said second client.

The technical solution proposed by the invention for implementing privileged conversation management in a messaging server for a client of an electronic instant conversation system does not require any modification of the main messaging module. Consequently, this solution can easily be integrated into existing electronic instant conversation servers.

The server further comprises means for storing and sending an unavailability message to clients other than the second client already in conversation with the first client.

The server may comprise means for storing instant messages sent by clients from the contacts list of the first client other than the second client or for redirecting said messages by electronic mail.

The invention also provides a privileged conversation manager module in an electronic instant conversation service between a plurality of clients each having at least one state of presence visible to the other clients that varies at least between “Available” and “Busy” or “Offline”, said module comprising means adapted, in response to a request for privileged conversation of a first client with a second client, to change the state of presence of said first client to “Busy” or “Offline” for all clients other than said second client.

The module further includes means for sending an unavailability message to clients already in conversation with the first client other than the second client and for storing said unavailability message.

The invention further provides an electronic instant conversation system comprising a plurality of clients connected to an electronic instant conversation server as described above.

To enable a user to request privileged conversation with one or more of the users in that user's contacts list, the clients comprise interface means for sending a privileged conversation request to the privileged conversation management module of the electronic instant conversation server.

### BRIEF DESCRIPTION OF THE DRAWINGS

Other features and advantages of the invention emerge from the following description of particular embodiments of the invention given by way of non-limiting example and with reference to the appended drawings, in which:

FIG. 1 is a diagram of an embodiment of an instant messaging system of the invention, and

FIG. 2 is a diagram of a prior art instant messaging system.

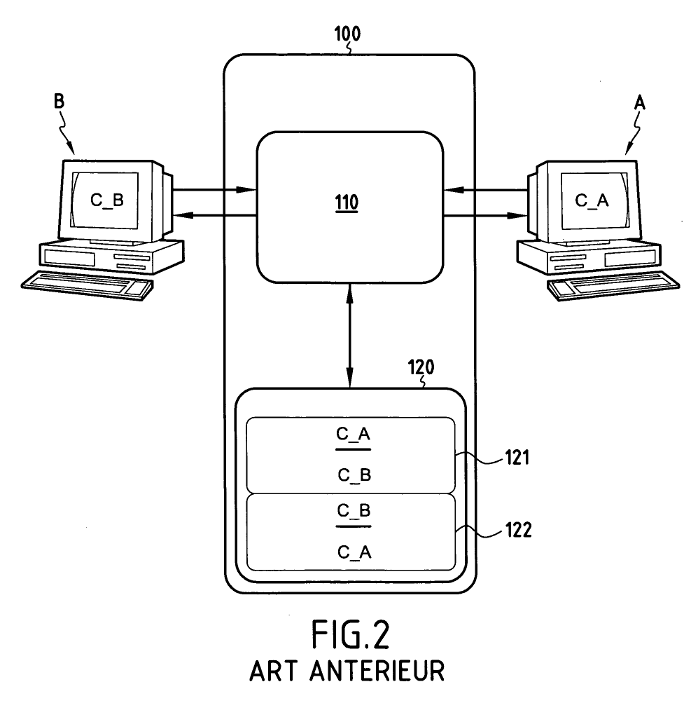

### DETAILED DESCRIPTION OF EMBODIMENTS OF THE INVENTION

The present invention applies to electronic instant conversation systems such as instant messaging systems and chat services. The invention proposes to integrate functions essentially in software form into the messaging servers usually employed to exchange instant messages between users. The functions offered are compatible with the standards and protocols used at present by instant conversation services, which means that these new functions can be integrated both into new instant conversation servers and into existing servers. These functions in software form may be made available remotely, for example from a dedicated server. In this case, the functions are made available in the form of an electronic data processing program that can be downloaded to the messaging servers.

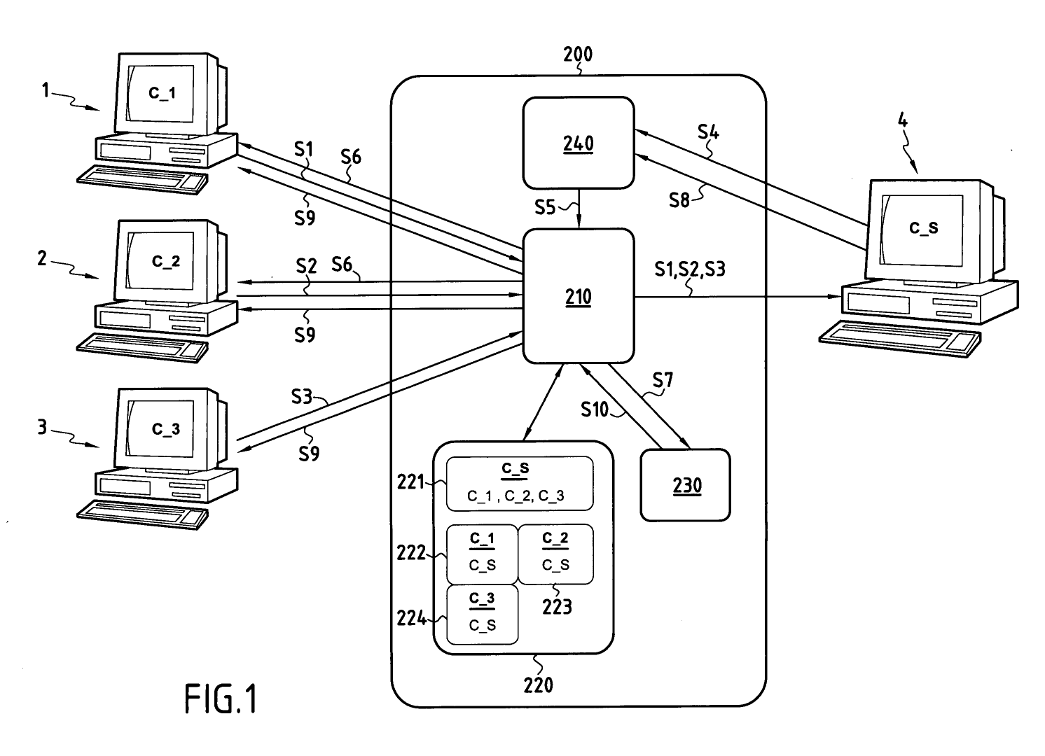

FIG. 1 is a general functional block diagram of a system of the invention showing the various portions thereof involved in executing the method of the invention. The system of the invention described here is implemented in an instant messaging system. The main portions of the system involved in an operation to limit the number of simultaneous conversations are one or more soliciting users (three users 1 to 3) each of whom has a terminal having an instant messaging client (C_1, C_2, C_3), a solicited user 4 who has a terminal having an instant messaging client C_S, and an instant messaging server 200. The instant messaging client (user agent) consists of software that a user employs to access an instant messaging service via a server using an identifier specific to the user. This is known in the art. The instant messaging client is used in particular to compose and to receive messages. The user also uses it to access the instant messaging server to manage the user's own contacts list.

For simplicity, the FIG. 1 system is represented with three soliciting instant messaging clients and one solicited instant messaging client. Nevertheless, given the following description, the person skilled in the art will readily envisage the implementation of a system of this kind on a larger scale, i.e. with different numbers of soliciting users and solicited users, and in particular greater numbers of soliciting users and solicited users.

In the FIG. 1 example, the users 1 to 4 have a fixed terminal of the personal computer type connected to a computer network and used to send and receive messages. Nevertheless, the present invention applies generally to all terminals that have means for sending and receiving instant messages via a communications network (e.g. a mobile telephone or a communicating personal digital assistant).

The communications network (not shown) connecting users' terminals to the instant messaging server may be an “open” network such as the Internet, a “closed” network such as a company Intranet or a partially open network using both a closed network and an open network.

The instant messaging server 200 is used to exchange instant messages between two or more users unambiguously identified to the server by their respective unique identifiers. The instant messaging server 200 comprises a main instant messaging module 210, a contacts lists module 220, a message processor module 230 and a privileged conversation manager module 240.

The main instant messaging module 210 (transfer agent), which is a software element of an instant messaging server well known in the art, handles state of presence management and exchange of messages between the instant messaging clients as a function of instant message routing rules. It also manages the contacts lists.

The module 220 is a database that is an integral part of the instant messaging server and contains all the contacts lists of all the messaging clients, in the present example the contacts list 221 of the client C_S, the contacts list 222 of the client C_1, the contacts list 223 of the client C_2 and the contacts list 224 of the client C_3.

The message processor module 230 receives instant messages that it has not been possible to route directly to their destination. More precisely, instant messages coming from instant messaging clients are received by this module when instant messaging users send messages to contacts representing an “Offline” or “Busy” state of presence/availability. Messages received by the module 230 can be stored until the state of presence/availability of the addressee of the messages changes to “Available”, at which time the stored messages are forwarded to the addressee. The module 230 can also redirect messages that it receives as electronic mail.

The privileged conversation manager module 240 is specific to the present invention. It receives directly from instant messaging clients requests to activate the process for privileging a conversation relative to one or more other conversations. This module interfaces with the main instant messaging module 210 to send it state of presence information and information messages to be forwarded to instant messaging clients. It is then seen as an instant messaging client by the main instant messaging module 210.

The default state of the privileged conversation manager module 240 is inactive and not involved in the exchange of instant messages or in differentiated presence management. When a user, for example user 4 of the instant messaging client C_S, uses that instant messaging client to privilege a conversation with user 3 of the instant messaging client C_3, for example, the instant messaging client C_S sends the privileged conversation manager module 240 a message informing it that the client C_S wishes to have a privileged conversation with the client C_3 although at the time it is in conversation with C_1, C_2 and C_3. The privileged conversation manager module 240 is then activated for the client C_S and sends the clients C_1 and C_2 a personalized information message (i.e. an unavailability message, for example “Please excuse me, I need to interrupt our conversation temporarily”) that is displayed in their instant message display window to inform them that the client C_S is temporarily unavailable.

The state of presence of user 4 then changes to “Busy” for all the instant messaging clients other than the client C_3 and new messages sent to the instant messaging client C_S of user 4 by users other than user 3 are managed in the same way as for the “Offline” state, i.e. they are received by the message processor module 230, which can store them temporarily pending a change to the state of presence of user 4, or redirect them via electronic mail using the electronic mail address of user 4.

When the conversation between the instant messaging clients C_S and C_3 ends, the instant messaging client C_S sends a message to the privileged conversation manager module 240 to inform it of the end of the privileged conversation.

The state of presence/availability of the messaging client C_S changes from “Busy” to “Available”. If messages sent by messaging clients other than C_3 have been stored by the message processor module 230, they are forwarded to user 4. The privileged conversation manager module 240 becomes inactive until it again receives a privileged conversation request from an instant messaging client.

The privileged conversation manager module 240 interfaces with the main instant messaging module 210 that forms part of the instant messaging server 200. The conversation manager module 240 automatically sends an information message via the main instant messaging module 210 indicating the unavailability of the user to all the instant messaging clients that it has not privileged in the conversation. The text of this message may be established (configured) by cooperation between the solicited messaging client, here the client C_S, and the privileged conversation manager module 240, which stores the message for each instant messaging user.

The user can configure the unavailability message and launch the privileged conversation process from the instant messaging client. To this end, the user, for example user 4 of the instant messaging client C_S, performs the configuration by selecting an “Unavailability message text” option, for example, that goes to a text entry window for composing an unavailability message to be sent automatically by the privileged conversation manager module 240 in the manner explained above. Once it has been composed, the unavailability message is sent to the module 240, which stores it.

Similarly, to launch the privileged conversation process, the user selects a “Request a privileged conversation” option in the menu of the instant messaging client, for example. This opens a window that prompts the user to indicate the instant messaging clients with which conversation is to continue. Once the instant messaging clients for the privileged conversation have been selected, the instant messaging client sends a message containing the selected clients to the privileged conversation manager module 240, which uses this message to determine the instant messaging clients for which the user is temporarily unavailable and that should receive the unavailability message.

The privileged conversation manager module 240 may be written in a language such as C++ or Java. Thus it may be integrated into the architecture of an instant messaging server (e.g. Jabber) and in this case use the standard eXtendable Messaging Presence Protocol (XMPP), which is based on XML. If the privileged conversation manager module of the invention is integrated into an instant messaging server, optionally one that already exists, the manager module must use a protocol compatible with that used by the main module of the instant messaging server.

An embodiment of the method of the invention used in the system shown in FIG. 1 is described next. In FIG. 1 the steps of a privileged conversation management operation that determines the number of simultaneous conversations are represented by arrows S1 to S9.

The embodiment to be described is subject to the following hypotheses:

users 1 to 3 of the respective soliciting instant messaging clients C_1 to C_3 are included in the contacts list 221 of user 4 of the solicited instant messaging client C_S which is itself included in the contacts lists 222 to 224 of the respective instant messaging clients C_1 to C_3, and

the instant messaging clients C_1 to C_3 solicit the instant messaging client C_S in the same time period, i.e. user 4 is going to have to manage three simultaneous conversations.

In a first step S1, the instant messaging client C_1 wishes to communicate by instant messaging with the instant messaging client C_S. The first conversation of C_S begins. The instant messaging client C_2 also wishes to communicate by instant messaging with the instant messaging client C_S. This is the second simultaneous conversation for C_S (step S2).

The third instant messaging client C_3 also wishes to communicate with the instant messaging client C_S. This is the third simultaneous conversation for C_S (step S3).

In each of the above steps, instant messages sent to the instant messaging client C_S by the instant messaging clients C_1, C_2 and C_3 pass in transit through the instant messaging server 210.

At this time, user 4 wishes to have a privileged conversation with user 3. To this end, user 4 uses the instant messaging client C_S to send the privileged conversation manager module 240 a message informing it that user 4 wishes to enter into privileged conversation with the instant messaging client C_3 (step S4). The instant messaging client C_S is at this time in conversation with the three instant messaging clients C_1 to C_3.

The module 240 is then activated and sends an unavailability message on behalf of user 4 to the instant messaging clients C_1 and C_2 to inform them that user 4 is no longer available for the conversations in progress. This message can be configured in advance and stored in the module 240 as described above. The module 240 sends information on the state of presence of the client C_S to the main instant messaging module 210 in order to change the state of the instant messaging client C_S to “Offline” or “Busy” for all the instant messaging clients in its contacts list 221 except for the instant messaging client C_3. The module 240 uses the main instant messaging module 210 as an instant messaging client to send this information (unavailability message and state of presence) (step S5).

Accordingly, the instant messaging clients C_1 and C_2 receive the unavailability message which is displayed in their instant message display window to inform them that the client C_S is temporarily unavailable (step S6).

All the instant messaging clients except the client C_3 with an “Offline” or “Busy” state of presence and new messages sent to the client C_S other than those coming from the client C_3 are managed in the same way as for the “Offline” state of presence, i.e. are processed by the message processor module 230 as described above (step S7). Moreover, the client C_3 sees the state of presence for the client C_S and the clients C_1 and C_2 as “Available”.

When the privileged conversation between the clients C_S and C_3 ends, the instant messaging client C_S automatically sends the privileged conversation manager module 240 a message informing it of the end of the privileged conversation (step S8). The state of presence of the instant messaging client C_S changes from “Busy” to “Available” for all the contacts in its contacts list 221 (C_1 to C_3) (step S9). The module 240 become inactive until a new privileged conversation is requested.

If the message processor module 230 has stored instant messages during the privileged conversation, they are sent to the instant messaging client C_S (step

Certain instant messaging clients may optionally be recognized as priority clients to whom the privileged conversation rules do not apply. For example, a user may set the parameters of such clients in that user's contacts list so as to be always available for those clients even when a privileged conversation has been requested.

We claim:

1. A method of managing privileged conversations in an electronic instant conversation service comprising a plurality of clients connected to a messaging server, each client having at least one state of presence visible to the other clients that varies at least between “Available” and “Busy” or “Offline”, said method comprising:
a step in which a first client sends a request for privileged conversation with a second client; and
in response to that request, a step in which the state of presence of said first client is changed to “Busy” or “Offline” for all clients other than said second client.

2. The method according to claim 1, further including a step in which an unavailability message is sent to clients already in conversation with the first client other than the second client.

3. The method according to claim 2, including a preliminary step in which the unavailability message is configured by the first client and stored on the messaging server.

4. The method according to claim 1, including a step of storing messages sent to said first client by clients other than the second client or a step of forwarding said messages by electronic mail.

5. An electronic instant conversation server comprising:
a main messaging module for managing an exchange of messages between clients each having at least one state of presence visible to the other clients that varies at least between “Available” and “Busy” or “Offline”; and
a privileged conversation manager module adapted, in response to a request for privileged conversation of a first client with a second client, to change the state of presence of said first client to “Busy” or “Offline” for all clients other than said second client.

6. The server according to claim 5, further including means for sending an unavailability message to the clients already in conversation with the first client other than the second client.

7. The server according to claim 6, including means for storing said unavailability message.

8. The server according to claim 5, including means for storing instant messages sent to said first client by clients other than said second client or for redirecting said messages by electronic mail.

9. A privileged conversation manager module in an electronic instant conversation service between a plurality of clients each having at least one state of presence visible to the other clients that varies at least between “Available” and “Busy” or “Offline”, said module comprising:
means adapted, in response to a request for privileged conversation of a first client with a second client, to change the state of presence of said first client to busy or offline for all the clients other than said second client.

10. The module according to claim 9, further including means for sending an unavailability message to clients already in conversation with the first client other than the second client.

11. The module according to claim 10, including means for storing said unavailability message.

12. An electronic instant conversation service system, comprising a plurality of clients connected to an electronic instant conversation server, comprising:
a main messaging module for managing the exchange of messages between the clients, each client having at least one state of presence visible to the other clients that varies at least between “Available” and “Busy” or “Offline”; and
a privileged conversation manager module adapted, in response to a request for privileged conversation of a first client with a second client, to change the state of presence of said first client to “Busy” or “Offline” for all clients other than said second client.

13. The system according to claim 12, wherein the clients include interface means for sending a privileged conversation request to the privileged conversation manager module of the electronic conversation server.

14. A computer program adapted to be executed on an electronic instant conversation server to manage the exchange of messages between clients each having at least one state of presence visible to the other clients that varies at least between “Available” and “Busy” or “Offline”, said program including instructions adapted, in response to a request for privileged conversation of a first client with a second client, to change the state of presence of said first client to “Busy” or “Offline” for all clients other than said second client.

15. A method of using a computer program according to claim 14, including the step of making said program available by downloading it.
